(19) United States
(12) Patent Application Publication
(10) Pub. No.: US 2025/0163204 A1
(43) Pub. Date: May 22, 2025

(54) Sustainable Polyester Polyols and Uses Thereof

(71) Applicant: Huntsman International LLC, The Woodlands, TX (US)

(72) Inventors: Kai Xi, The Woodlands, TX (US); Todd Bates, The Woodlands, TX (US); Annelies Vandevelde, Everberg (BE)

(21) Appl. No.: 18/841,819

(22) PCT Filed: Feb. 28, 2023
(86) PCT No.: PCT/US2023/014064

§ 371 Date: Aug. 27, 2024

Related U.S. Application Data
(60) Provisional application No. 63/316,548, filed on Mar. 4, 2022.

(51) Int. Cl. C08G 18/40; A47C 7/18; B60N 2/64; B60R 13/00; C08G 18/42; C08G 18/48; C08G 18/64; C08G 18/76

(52) U.S. Cl. CPC C08G 18/4081; C08G 18/4225; C08G 18/4833; C08G 18/64; C08G 18/7671; A47C 7/18; B60N 2/64; B60R 13/00; C08G 2110/0008; C08G 2110/0075; C08G 2110/0083

(57) ABSTRACT

The present disclosure provides an isocyanate-reactive hydrogen composition including an increased amount of a sustainable polyester polyol. The isocyanate-reactive hydrogen composition may be combined with a polyisocyanate composition to form a reaction system which can be reacted and expansion moulded to form a flexible foam. The flexible foam that is produced may be used in a variety of applications, such as in automotive and furniture seating.

### CROSS REFERENCE TO RELATED APPLICATIONS

This application claims priority to U.S. patent application No. 63/316,548 filed Mar. 4, 2022. The noted application is incorporated herein by reference.

### STATEMENT REGARDING FEDERALLY SPONSORED RESEARCH OR DEVELOPMENT

Not applicable.

### FIELD

The present disclosure is generally directed to an isocyanate-reactive composition comprising at least 15% by weight of a sustainable polyester polyol, a process for producing a flexible foam by reacting the polyol composition and a polyisocyanate composition and the flexible foam obtained from such process.

### BACKGROUND

Flexible polyurethane foam is used extensively in a variety of applications requiring the unique mechanical, sound absorbing, load-bearing and/or other properties this material provides. Flexible polyurethane foams are made by the reaction of at least one polyisocyanate containing isocyanate (NCO) groups with at least one polyol containing hydroxyl (OH) groups in the presence of blowing agent, surfactant, catalyst and other optional additives. The blowing agent most commonly used is water,

The flexible foam industry has witnessed a significant increase in the use of sustainable and/or bio-based polyols, which are incorporated into a formulation at the expense of petroleum-based polyether polyols. The ability to claim a level of bio-renewable content within the foam provides a competitive marketing advantage relative to those not incorporating this type of polyol.

However, there are challenges to the use of bio-based polyols as raw materials in the production of polyurethane foam products. In particular, when bio-based polyols are used at levels greater than 10% by weight in existing polyurethane foam formulations, certain physical properties (for e.g., humid aged tensile, wet compression set, hysteresis loss, et al.) are deteriorated relative to foams made solely from petroleum-based polyols. The loss of these physical properties effectively limits the amount of bio-based polyol that can be incorporated into a flexible foam or formulation.

In view of the foregoing, developments that enable the improvement of the mechanical strength properties of flexible foams made from sustainable and/or polyols and the use of higher concentrations of such sustainable and/or bio-based polyols without resulting in a loss of mechanical strength properties would represent a significant advancement in the art.

### SUMMARY

The present disclosure describes an isocyanate-reactive hydrogen composition including at least 15% by weight, based on the total weight of components containing an isocyanate-reactive hydrogen present in the composition, of a sustainable polyester polyol derived from (i) a thermoplastic polyester, (ii) a hydroxylated material, and (iii) a hydrophobic material. The sustainable polyester polyol may have a primary hydroxyl content of at least about 30%, calculated on the number of primary and secondary hydroxyl groups in the polyester polyol.

The present disclosure also provides a reaction system containing a polyisocyanate composition and the isocyanate-reactive composition including the sustainable polyester polyol and a first polyether polyol having polyether chains containing at least about 50% by weight ethylene oxide (EO), based on the total weight of the first polyether polyol and water.

In yet another embodiment, there is a provided a process for producing a flexible foam by reacting and expansion moulding the reaction system above. The flexible foam may be used in a variety of applications, such as in automotive and furniture seating or in automotive carpet, dash insulation, steering wheels or instrument panels.

### DETAILED DESCRIPTION

The present disclosure provides an isocyanate-reactive hydrogen composition containing a sustainable polyol, and its use in producing flexible foam. One of the advantages of the isocyanate-reactive hydrogen composition of the present disclosure is at least 15% by weight of petroleum-based polyols may be replaced by the sustainable polyester polyol (i.e. a polyester polyol made from sustainable materials and in some embodiments sustainable and bio-based materials) and used to produce a flexible foam that does not exhibit a deterioration in mechanical strength properties typically seen when state of the art bio-based polyols are used at similar levels. The term “bio-based” materials as used herein refers to materials which are derived from vegetable, animal, or microbial sources. Preferably, they will be derived from vegetable sources. The term “sustainable” means that the materials used to produce the polyester polyol of the present disclosure are generated from resources that are sustainable over an extended period of time (i.e., from resources that are renewable or recycled).

If appearing herein, the term “comprising” and derivatives thereof are not intended to exclude the presence of any additional component, step, or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The terms “or” and “and/or”, unless stated otherwise, refer to the listed members individually as well as in any combination. For example, the expression A and/or B refers to A alone, B alone, or to both A and B.

The articles “a” and “an” are used herein to refer to one or to more than one (i.e., to at least one) of the grammatical objects of the article. By way of example, “a polyisocyanate” means one polyisocyanate or more than one polyisocyanate. The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment. If the specification states a component or feature “may”, “can”, “could”, or “might” be included or have a characteristic, that particular component or feature is not required to be included or have the characteristic.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The term “optional” or “optionally” means that the subsequently described event or circumstance may or may not occur, and that the description includes instances where said event or circumstance occurs and instances where it does not.

“Isocyanate index” or “NCO index” or “index” refers to the ratio of NCO-groups over isocyanate-reactive hydrogen atoms present in a formulation, given as a percentage: [NCO]×100/[active hydrogen] (%). In other words, the NCO-index expresses the percentage of isocyanate actually used in a formulation with respect to the amount of isocyanate theoretically required for reacting with the amount of isocyanate reactive hydrogen used in a formulation. It should be observed that the isocyanate index as used herein is considered from the point of view of the actual foaming process involving the isocyanate ingredients and the isocyanate-reactive ingredients. Any isocyanate groups consumed in a preliminary step to produce modified polyisocyanates (including such isocyanate derivatives referred to in the art as prepolymers) or any active hydrogens consumed in a preliminary step (e.g., reacted with isocyanate to produce modified polyols or polyamines) are not taken into account in the calculation of the isocyanate index. Only the free isocyanate groups and the free isocyanate-reactive hydrogens (including those of the water) present at the actual foaming stage are taken into account.

The expression “isocyanate-reactive hydrogens” as used herein for the purpose of calculating the isocyanate index refers to the total of active hydrogen atoms in hydroxyl and amine groups present in the isocyanate-reactive hydrogen compositions; this means that for the purpose of calculating the isocyanate index of the actual foaming process, one hydroxyl group is considered to comprise one reactive hydrogen, one primary amine group is considered to comprise one reactive hydrogen and one water molecule is considered to comprise two active hydrogens.

The term “components containing an isocyanate-reactive hydrogen” refers to compounds having an isocyanate reactive hydrogen.

The term “reaction system” refers to a combination of components where the polyisocyanates are kept in one or more containers separate from the isocyanate-reactive hydrogen components.

The expression “polyurethane foam’ as used herein refers to cellular products as obtained by reacting polyisocyanates with isocyanate-reactive hydrogen components, using foaming agents, and in particular includes cellular products obtained with water as reactive foaming agent (involving a reaction of water with isocyanate groups yielding urea linkages and carbon dioxide and producing polyurea-urethane foams) and with polyols, and optionally amino alcohols and/or polyamines as isocyanate-reactive hydrogen components.

The term “hydroxyl value” refers to the concentration of hydroxyl groups, per unit weight of the polyol, that are able to react with the isocyanate groups. The hydroxyl number is reported as mg KOH/g, and may be measured according to the standard ASTM D 1638.

The term “average functionality”, or “average hydroxyl functionality” of a polyol indicates the number of OH groups per molecule, on average. The average functionality of an isocyanate refers to the number of-NCO groups per molecule, on average.

The term “substantially free” refers to a composition in which a particular constituent or moiety is present in an amount that has no material effect on the overall composition. In some embodiments, “substantially free” may refer to a composition in which the particular constituent or moiety is present in the composition in an amount of less than about 5 wt. %, or less than about 4 wt. %, or less than about 3 wt. % or less than about 2 wt. % or less than about 1 wt. %, or less than about 0.5 wt. %, or less than about 0.1 wt. %, or less than about 0.05 wt. %, or even less than about 0.01 wt. % based on the total weight of the composition, or that no amount of that particular constituent or moiety is present in the respective composition.

Accordingly, the present disclosure provides an isocyanate-reactive hydrogen composition including one or more components containing isocyanate-reactive hydrogens. In one embodiment, the isocyanate-reactive composition includes at least about 15% by weight of a sustainable polyester polyol, where the % by weight is based on the total weight of the components containing isocyanate-reactive hydrogens.

The sustainable polyester polyol may be derived from (i) a thermoplastic polyester, (ii) a hydroxylated material, and (iii) a hydrophobic material. In one embodiment, the sustainable polyester polyol has a primary hydroxyl content of at least about 30%, or at least 35%, or at least 40%, or at least 45%, calculated on the number of primary and secondary hydroxyl groups in the polyester polyol. In other embodiments, the sustainable polyester polyol has a primary hydroxyl content of at least about 50%, or at least about 55% or at least about 60% or at least about 65%, or at least about 70%, or at least about 75%, or at least about 80%, or at least about 85% or at least about 90% or at least about 95%, calculated based on the number of primary and secondary hydroxyl groups in the polyester polyol. In still other embodiments, the sustainable polyester polyol has a primary hydroxyl content of between about 35%-100%, or between about 40%- 97%, or between about 45%- 95% or between about 55%-90% or between about 60%- 85%, calculated based on the number of primary and secondary hydroxyl groups in the polyester polyol. In still other embodiments, the sustainable polyester polyol is substantially free of secondary hydroxyl groups.

Thermoplastic polyesters which may be used in making the sustainable polyester polyol are well known in the art. They are condensation polymers produced from the reaction of glycols and aromatic dicarboxylic acids or acid derivatives. Examples include, but are not limited to, polyethylene terephthalate (PET), polybutylene terephthalate (PBT), polytrimethylene terephthalate (PTT), glycol-modified polyethylene terephthalate (PETG), copolymers of terephthalic acid and 1,4-cyclohexanedimethanol (PCT), PCTA (an isophthalic acid-modified PCT), polyhydroxy alkanoates, for e.g., polyhydroxybutyrate, copolymers of diols with 2,5-furandicarboxylic acid or dialkyl 2,5-furandicarboxylates, for e.g., polyethylene furanoate, copolymers of 2,2,4,4-tetramethyl-1,3-cyclobutanediol with isophthalic acid, terephthalic acid or orthophthalic derivatives, dihydroferulic acid polymers and mixtures thereof. In one embodiment, the thermoplastic polyesters include virgin polyesters, recycled polyesters, or mixtures thereof. Polyethylene terephthalate is particularly preferred, especially recycled polyethylene terephthalate (rPET), virgin PET, and mixtures thereof. More examples of suitable thermoplastic polyesters can be found in U.S. Pat. Appl. Publ. No. 2009/0131625, the teachings of which are incorporated herein by reference.

The thermoplastic polyester component of the sustainable polyester polyol can comprise, for example, from about 5% by weight to about 50% by weight of the total weight of the sustainable polyester polyol. In other embodiments, the sustainable polyester polyol can comprise, for example, from about 15% by weight to about 40% by weight, or about 20% by weight to about 35% by weight of the total weight of the sustainable polyester polyol.

The hydroxylated material of the sustainable polyester polyol can be, for example, at least one aliphatic diol, at least one derivative thereof, or a combination thereof.

In one embodiment, the hydroxylated material may be an aliphatic diol having a formula:

HO—R1—OH
where R1 is a divalent radical selected from the group consisting of: (a) an alkylene radical containing from 2 to 12 carbon atoms, (b) a radical of the formula:

—(R2O)n—R2—
where R2 is an alkylene radical containing from 2 to 4 carbon atoms, and n is an integer from 1 to 20 and (c) a mixture thereof.

Examples of suitable aliphatic diols include ethylene glycol, propylene glycol, diethylene glycol, dipropylene glycol, trimethylene glycol, butylene glycol, polyethylene glycol, 1,2-cyclohexanediol, a poly(oxyalkylene) polyol containing from two to four alkylene radicals derived by the condensation of ethylene oxide, propylene oxide, or any combination thereof, and the like. As those skilled in the art will appreciate, in the preparation of mixed poly(oxyethylene-oxypropylene) polyols, the ethylene and propylene oxides may be added to a starting hydroxyl-containing reactant either in admixture or sequentially. Mixtures of such diols can be employed, if desired.

In one embodiment, the hydroxylated material can be, for example, diethylene glycol, glycerol, polyethylene glycol, trimethylolpropane, pentaerythritol, ethylene glycol, propylene glycol, dipropylene glycol, trimethylene glycol, butylene glycol, 1,2-cyclohexanediol, hexane diol, pentane diols, polyoxyalkylene diols (e.g., tri and tetra ethylene glycol), derivatives thereof, and combinations thereof.

The hydroxylated material of the sustainable aromatic polyester polyol can comprise, for example, from about 30% by weight to about 80% by weight of the total weight of the sustainable aromatic polyester polyol. Alternatively, the hydroxylated material of the sustainable aromatic polyester polyol can comprise from about 35% by weight to about 65% by weight of the total weight of the sustainable polyester polyol. Alternatively, the hydroxylated material in the sustainable polyester polyol can comprise from about 40% by weight to about 60% by weight of the total weight of the sustainable aromatic polyester polyol.

The hydrophobic material may include, for example, natural oils (e.g., triglycerides (especially fats and oils)) derived from renewable resources. The natural oils may be unmodified (e.g., do not contain a hydroxyl functional group), functionalized natural oil polyols or a combination thereof. Suitable natural oils include, for example, triglyceride oils, coconut oil, cochin oil, corn oil, cottonseed oil, linseed oil, olive oil, palm oil, palm kernel oil, peanut oil, soybean oil, sunflower oil, tall oils, tallow, lesquerella oil, tung oil, whale oil, tea seed oil, sesame seed oil, safflower oil, rapeseed oil, fish oils, derivatives thereof, and combinations thereof. Suitable derivatives thereof of natural oils include, but are not limited to, fatty acids, fatty acid methyl esters and fatty acid alkanolamides. Examples of fatty acids include, but are not limited to, caproic, caprylic, capric, lauric, myristic, palmitic, stearic, oleic, linoleic, linolenic, ricinoleic, and mixtures thereof. Another suitable fatty acid is 2-ethylhexanoic acid. Examples of fatty acid methyl esters include, but are not limited to, methyl caproate, methyl caprylate, methyl caprate, methyl laurate, methyl myristate, methyl palmitate, methyl oleate, methyl stearate, methyl linoleate, methyl linolenate, and mixtures thereof. Examples of fatty alkanolamides include, but are not limited to, tall oil fatty acid diethanolamide, lauric acid diethanolamide, and oleic acid monoethanolamide. These suitable natural oils can be functionalized by epoxidizing and/or hydroxylating reactions.

In some embodiments, the natural oil component can be, for example, castor oil, corn oil, soybean oil, functionalized castor oil, functionalized coconut oil, functionalized cochin oil, functionalized corn oil, functionalized cottonseed oil, functionalized linseed oil, functionalized olive oil, functionalized palm oil, functionalized palm kernel oil, functionalized peanut oil, functionalized soybean oil, functionalized sunflower oil, functionalized tall oils, functionalized tallow, functionalized lesquerella oil, functionalized tung oil, functionalized whale oil, functionalized tea seed oil, functionalized sesame seed oil, functionalized safflower oil, functionalized rapeseed oil, functionalized fish oils, and combinations thereof.

In some embodiments, the natural oil polyol is a functionalized natural oil that can be prepared by epoxidizing the natural oil and subsequently reacting the epoxidized oil with water and/or a hydroxylated material to convert the epoxy groups to OH groups. Epoxidized natural oils are commercially available, or alternatively can be prepared by reacting unsaturated natural oils with a peroxyacid to form the epoxidized oil. Various methods are described in the art for preparing epoxidized oils, including for example the methods described in U.S. Pat. Nos. 6,107,433; 6,433,121; 6,573,354; and 6,686,435. Suitable materials for use in converting the epoxy groups to OH groups include any reactive hydrogen compounds such as hydrogen, water, lithium aluminum hydride, sodium borohydride, ammonia, or aliphatic or aromatic amines; aliphatic or aromatic alcohols and their alkoxides (mono functional), glycols, triols, tetraols, sugars etc.; carboxylic acids; mineral acids, including, for example, hydrochloric, sulfuric, and phosphoric acids. An amount of hydroxylated material is reacted with the epoxidized triglyceride oil sufficient to convert from about 10% to about 100% of the epoxy groups to hydroxy groups.

The hydroxylation of the epoxidized natural oil can take place at temperatures ranging from about 50° C. to about 250° C. and at pressures ranging from 0 psi to about 4000 psi. The resulting natural oil based polyol may have an OH value ranging from about 25 mg KOH/g to about 500 mg KOH/g and an acid value of from about 0 mg KOH/g to about 10 mg KOH/g.

In some embodiments the hydrophobic material can comprise from about 1% by weight to about 50% by weight of the total weight of the sustainable polyester polyol, or alternatively from about 5% by weight to about 40% by weight of the total weight of the sustainable polyester polyol, or alternatively from about 10% by weight to about 30% by weight of the total weight of the sustainable polyester polyol.

The sustainable polyester polyol may be made by placing components (i) to (iii) into a reaction vessel and subjecting the reactive mixture to esterification/transesterification reaction conditions at temperatures ranging from about 50° C. to about 300° C. for a period ranging from about 1 hour to about 48 hours (e.g., about 5 hours to about 24 hours). Any volatile by-products of the reaction, such as water, methanol or ethylene glycol, can be removed from the process thereby forcing the ester interchange reaction to completion. The synthesis of the sustainable bio-based polyester polyol may take place under reduced pressure or at atmospheric pressure or at increased pressure. In some embodiments, components (i) and (ii) may be pre-reacted with one another along with volatile by-product removal to form an intermediate product. The intermediate product can then react with the remaining component (iii) through esterification/transesterification reaction conditions to form the sustainable polyester polyol.

An esterification/transesterification catalyst may be used during synthesis to increase the rate of reaction. Examples of suitable esterification/transesterification catalyst include tin catalysts (e.g., FASCAT® catalyst available from Arkema, Inc.), titanium catalyst (e.g., TYZOR® TBT catalyst, TYZOR® TE catalyst both available from Dork Ketal Chemical LLC), alkali catalysts (e.g., sodium hydroxide, potassium hydroxide, sodium and potassium alkoxides), acid catalyst (e.g., sulfuric acid, phosphoric acid, hydrochloric acid, sulfonic acid), enzymes, or combinations thereof. The esterification/transesterification catalyst can be present in an amount ranging from about 0.001% by weight to about 0.2% by weight based on the total weight of the sustainable polyester polyol.

According to one embodiment, the sustainable polyester polyol may have an acid value (mg KOH/g) of about <5.0, or about <2.0, or about <1.75, or about <1.5. In another embodiment the sustainable polyester polyol may have a hydroxyl number (mg KOH/g) of about 10 to about 200, or about 25 to 100, or about 50 to about 65, or about 55 to about 60. In still another embodiment the sustainable polyester polyol may have a viscosity (centipoise at 25° C.) of about 200 to about 100000, or about 1000 to about 10000, or about 3000 to about 5500, or about 3500 to about 5000. In yet another embodiment the sustainable polyester polyol may have a water content (wt %) of about <0.5, or about <0.2, or about <0.1.

In one embodiment, the sustainable polyester polyol is present in the isocyanate-reactive hydrogen composition in an amount of at least about 16% by weight, or at least about 17% by weight, or at least about 18% by weight, or at least about 19% by weight, or at least about 20% by weight, or at least about 21% by weight, or at about least 22% by weight, or at least about 23% by weight, or at least about 24% by weight or at least about 25% by weight, or at least about 26% by weight, or at least about 27% by weight, or at least about 28% by weight, or at least about 29% by weight, or at least about 30% by weight about 31% by weight, or at least about 32% by weight, or at least about 33% by weight, or at least about 34% by weight or at least about 35% by weight, based on the total weight of the components containing isocyanate-reactive hydrogens.

In another embodiment, the sustainable polyester polyol is present in the isocyanate-reactive hydrogen composition in a range from about 15% by weight to about 45% by weight, or about 18% by weight to about 40% by weight, or about 20% by weight to about 35% by weight, based on the total weight of the components containing isocyanate-reactive hydrogens.

In another embodiment, the isocyanate-reactive hydrogen composition also includes a first polyether polyol comprising polyether chains containing at least about 50% by weight ethylene oxide (EO), based on the total weight of the first polyether polyol. In some embodiments, the first polyether polyol may comprise polyether chains containing at least about 60% by weight, or at least about 65% by weight, or at least about 70% by weight, or at least about 75% by weight, or at least about 80% by weight, or at least about 85% by weight, or at least about 90% by weight or at least about 95% by weight ethylene oxide content, based on the total weight of the first polyether polyol. In still other embodiments, the first polyether polyol may comprise an EO content of at least about 50%- 100% by weight, or at least about 60%- 90% by weight or at least about 65%- 85% by weight, based on the total weight of the polyether polyol.

Preferably, the remainder of the alkylene oxide content in the polyether chains of the first polyether polyol is derived from propylene and/or butylene oxide. More preferably, the remainder of the alkylene oxide content in the polyether chains of the first polyether polyol is derived from propylene oxide. Therefore, the polyether chains of the first polyether polyol preferably comprise no more than about 50% by weight propylene oxide content, more preferably no more than about 35% by weight propylene oxide content, even more preferably no more than about 30% by weight propylene oxide content, based on the total weight of the first polyether polyol.

The distribution of the oxyethylene groups and other oxyalkylene groups (if present) over the polyether chain may be of the type of a random distribution, a block copolymer distribution or a combination thereof.

The first polyether polyol may be suitably based on a hydroxyl-containing starting compound, for example one or more polyfunctional alcohols, containing in the range of from 2 to 8 hydroxyl groups. Polyether polyols based on a mixture of such hydroxyl-containing starting compounds may also be used as the first polyether polyol. Examples of suitable polyfunctional alcohols include glycols, glycerol, pentaerythritol, trimethylolpropane, triethanolamine, sorbitol and mannitol. Advantageously, the first polyether polyol is based on a starting compound selected from glycerol or a mixture of propylene glycol (MPG) and glycerol.

In some embodiments, the first polyether polyol may have an average nominal functionality of at least 1.5, or at least 2, or at least 2.5 or at least 3. The average nominal functionality of the first polyether polyol may be at most 8, or at most 6. In other embodiments, the first polyether polyol may have an average equivalent weight of an average equivalent weight of 200-2000 Da and preferably of 200-1800 Da and a molecular weight of 600-8000 Da, preferably of 600-5000 Da. In still other embodiments, the first polyether polyol may have a hydroxyl value of at least 28, while in other embodiments, the hydroxyl value is at most 48.

The first polyether polyol may be prepared by any suitable process known in the art, for example by ring-opening polymerization of alkylene oxide onto the hydroxyl containing starting material in the presence of a composite metal cyanide complex catalyst or a KOH catalyst.

In some embodiments, the first polyether polyol may be present in the isocyanate-reactive hydrogen composition in an amount of at least about 40% by weight, or at least about 45% by weight, or at least about 50% by weight, or at least about 55% by weight, based on the total weight of the components containing isocyanate-reactive hydrogens. In other embodiments, the first polyether polyol may be present in the isocyanate-reactive hydrogen composition in an amount of from about 35%-70% by weight, or from about 40%-65% by weight, or from about 45%-55% by weight, based on the total weight of the components containing isocyanate-reactive hydrogens.

According to another embodiment, the isocyanate-reactive composition may include other components containing isocyanate-reactive hydrogens which may be present in an amount of from 0-15% by weight, based on the total weight of the components containing isocyanate reactive hydrogens. Such other components containing isocyanate-reactive hydrogens may be selected from chain extenders, cross-linkers, polyether polyamines, polyols which are different from the sustainable polyester polyol and the first polyether polyol of the present disclosure, water and a mixture thereof.

The chain extenders, which contain two (2) isocyanate-reactive hydrogens, may be selected from an amine, an amino-alcohol, and a diol, of which diols are preferably used. Further the chain extenders may be aromatic, cycloaliphatic, araliphatic and aliphatic, of which aliphatic ones are preferably used. The chain extenders may have an average equivalent weight of less than 150. Most preferred are aliphatic diols such as ethylene glycol, 1,3-propanediol, 2-methyl-1,3-propanediol, 1,4-butanediol, 1,5-pentanediol, 1,6-hexanediol, 1,2-propanediol, 1,3-butanediol, 2,3-butanediol, 1,3-pentanediol, 1,2-hexanediol, 3-methylpentane-1,5-diol, 2,2-dimethyl-1,3-propanediol, diethylene glycol, dipropylene glycol and tripropylene glycol, and aromatic diols and propoxylated and/or ethoxylated products thereof.

The cross-linkers are isocyanate-reactive hydrogen components containing 3-8 isocyanate-reactive hydrogens and, preferably, have an average equivalent weight of less than 150. Examples of such cross-linkers include glycerol, trimethylolpropane, pentaerythritol, triethanolamine, polyoxyethylene polyols having an average nominal functionality of 3-8 and an average equivalent weight of less than 150, like ethoxylated glycerol, trimethylol propane and pentaerythritol having an equivalent weight of less than 150, and polyether triamines having an equivalent weight of less than 150.

Polyether polyamines may be selected from polyoxypropylene polyamines, polyoxyethylene polyamines and polyoxypropylene polyoxyethylene polyamines, preferably having an equivalent weight of 150-3000 (number average molecular weight divided by the number of amine groups at the end of the polymer claims). Such polyether polyamines are known in the art including Jeffamine® ED2003 and T5000 amines.

The polyols may be polyester polyols (which are different from the sustainable polyester polyol of the present disclosure), polythioethers, polycarbonates, polyacetals, polyolefins, polysiloxanes or polyethers (which are different from the first polyether polyol). Polyester polyols which may be used include hydroxyl-terminated reaction products of dihydric alcohols such as ethylene glycol, propylene glycol, diethylene glycol, 1,4-butanediol, neopentyl glycol, 1,6-hexanediol or cyclohexane dimethanol or mixtures of such dihydric alcohols, and dicarboxylic acids or their ester-forming derivatives, for example succinic, glutaric and adipic acids or their dimethyl esters, sebacic acid, phthalic anhydride, tetrachlorophthalic anhydride or dimethyl terephthalate or mixtures thereof. Polythioether polyols, which may be used, include products obtained by condensing thiodiglycol either alone or with other glycols, alkylene oxides, dicarboxylic acids, formaldehyde, amino-alcohols or aminocarboxylic acids. Polycarbonate polyols which may be used include products obtained by reacting diols such as 1,3-propanediol, 1,4-butanediol, 1,6-hexanediol, diethylene glycol or tetraethylene glycol with diaryl carbonates, for example diphenyl carbonate, or with phosgene. Polyacetal polyols which may be used include those prepared by reacting glycols such as diethylene glycol, triethylene glycol or hexanediol with formaldehyde. Suitable polyacetals may also be prepared by polymerizing cyclic acetals. Suitable polyolefin polyols include hydroxy-terminated butadiene homo- and copolymers and suitable polysiloxane polyols include polydimethylsiloxane diols. Polyether polyols different from the first polyether polyol have an EO content of less than about 50% by weight, based on the total weight of the polyether polyol, and may have an average equivalent weight of 150-4000 and more preferably of 150-2500 and preferably have an average functionality of 2-4. Such polyols include polyoxyethylene polyoxypropylene polyols, wherein the oxyethylene and oxypropylene units are distributed randomly, in block form or a combination thereof, and polyoxypropylene polyols and/or polyoxyethylene polyols, and polyoxyethylene glycols having a molecular weight of 600-1000. The polyol may also comprise dispersions or solutions of addition or condensation polymers in polyols of the types described above. Such modified polyols, often referred to as “polymer polyols” and which have been fully described in the prior art and include products obtained by the in situ polymerization of one or more vinyl monomers, for example styrene and/or acrylonitrile, in the above polyether polyols, or by the in situ reaction between a polyisocyanate and an amino- and/or hydroxy-functional compound, such as triethanolamine, in the above polyol. Polyoxyalkylene polyols containing from 1-50% by weight of dispersed polymer may be particularly useful. Particle sizes of the dispersed polymer of less than 50 microns are preferred.

The isocyanate-reactive hydrogen composition may also include one or more known additives, including, but not limited to, catalysts enhancing the formation of urethane bonds like tin catalysts like tin octoate and dibutyltindilaurate, tertiary amine catalysts like triethylenediamine and imidazoles like dimethylimidazole and other catalysts like maleate esters and acetate esters; non-ionic surfactants; silicon-based surfactants; fire retardants; smoke suppressants; UV-stabilizers; colorants; microbial inhibitors; fillers; internal mould release agents (such agents may be used to further enhance the release of the materials made but are not essential) and external mould release agents (such agents preferably are only used at the beginning of the first moulding as explained later).

A particularly preferred class of catalysts is an alkali metal or alkaline earth metal carboxylate salt. The catalyst may be a salt of any metal of Groups IA and IIA of the Periodic Table but in general the alkali metal salts are preferred like potassium and sodium salts, especially the potassium salts. If desired mixtures of such salts may be used like a mixture of a potassium and a sodium salt.

The carboxylate may be selected from aliphatic carboxylates having 2-10 carbon atoms like acetate, hexanoate, 2-ethylhexanoate and octanoate. Especially, the carboxylate may be selected from those having the formula:

R—E—A—COO—,
where A is a hydrocarbon diradical having 1-6 preferably 1-3 carbon atoms;
E is —O— or
and R is X—R1—(OR2)n— where X is CH3— or OH—, R1 is a hydrocarbon diradical having 1-8 and preferably 1-4 carbon atoms, R2 is a hydrocarbon diradical having 2-4 and preferably 2 or 3 carbon atoms and n is an integer from 0 to 10, preferably 0-5.

In some embodiments, A may be selected from diradicals like —CH2, CH2CH2—, —CH2CH2CH2—, —CH═CHCH2—, —CH2—CH═CH, and —CH═CH—.

In some embodiments, R1 may be selected from those diradicals mentioned for A and from radicals obtained by removing two hydrogen atoms from e.g., butane, pentane, hexane and octane. The most preferred radicals for R1 are methylene, ethylene, trimethylene, tetramethylene and propylene.

In some embodiments, R2 may be selected from ethylene, trimethylene, tetramethylene, ethylethylene and propylene. Most preferred groups are ethylene and propylene.

Such catalysts and their preparation are known (i.e., EP 294161, EP 220697 and EP 751114). Examples of catalysts are sodium acetate, potassium acetate, potassium hexanoate, potassium 2-ethylhexanoate, potassium ethoxyacetate, sodium ethoxyacetate, the potassium salt of the hemi-ester of maleic acid and ethoxyethane, ethoxyethoxyethane, ethylene glycol, diethylene glycol, triethylene glycol, tetraethylene glycol, propylene glycol, dipropylene glycol, tripropylene glycol, methanol, ethanol, propanol or butanol and the potassium salt of the hemi-ester of such hydroxy containing compounds with malonic, succinic, glutaric, adipic or fumaric acid. Mixtures of these catalysts may be used as well. Catalysts may be typically used in small amounts, for example, each catalyst being employed from about 0.0015 parts by weight to about 5 parts by weight or about 0.1 parts by weight to about 0.5 parts by weight, per 100 parts by weight of the components containing isocyanate-reactive hydrogens.

Water can be used as blowing agent, optionally together with other blowing agents known in the art like hydrocarbons, so called CFC's and HCFC's, N2 and CO2. Most preferably water is used as the blowing agent, optionally together with CO2. The amount of blowing agent will depend on the desired density of the flexible foam. In some embodiments, the amount of blowing agent present in the isocyanate-reactive hydrogen composition may be from about 0.8%- 5% by weight, based on the total weight of the components containing isocyanate-reactive hydrogens.

According to another embodiment, there is provided a reaction system comprising the isocyanate-reactive hydrogen composition of the present disclosure and a polyisocyanate composition.

In one embodiment, the polyisocyanate composition includes an organic polyisocyanate. The organic polyisocyanate may be: (1) a diphenylmethane diisocyanate comprising at least 40%, preferably at least 50% or at least 60% and most preferably at least 85% by weight of 4,4′-diphenylmethane diisocyanate (4,4′-MDI); (2) a carbodiimide and/or uretonimine modified variant of diphenylmethane diisocyanate (1) having an NCO value of 20% by weight or more; (3) a urethane modified variant of diphenylene diisocyanate (1) having an NCO value of 20% by weight or more and being the reaction product of an excess of diphenylmethane diisocyanate (1) and of a polyol having an average nominal hydroxyl functionality of 2-4 and an average molecular weight of at most 1000, such as; (4) a prepolymer having an NCO value of 20% by weight or more and which is the reaction product of an excess of any of the aforementioned organic polyisocyanates (1) to (3) and of a polyol having an average nominal hydroxyl functionality of 2-6, an average molecular weight of 2000-12000 and preferably a hydroxyl value of 15 to 60 mg KOH/g such as petroleum-based polyester polyols and polyether polyols and especially from polyoxyethylene polyoxypropylene polyols having an average nominal hydroxyl functionality of 2-4, an average molecular weight of 2500-8000, and preferably a hydroxyl value of 15-60 and preferably either an oxyethylene content of 5-25% by weight, which oxyethylene preferably is at the end of the polymer chains, or an oxyethylene content of 50-90% by weight, which oxyethylene preferably is randomly distributed over the polymer chains, or (5) a mixture of any of the aforementioned organic polyisocyanates. Organic polyisocyanates (1) and (2) and mixtures thereof are preferred as the organic polyisocyanate.

The organic polyisocyanate may be blended with one or more other polyisocyanates that are neither of the organic polyisocyanates (1) to (4) above. If present, such other polyisocyanate may constitute, for example, up to 25% by weight, or up to 10% by weight or up to 5% by weight, based on the total weight of the polyisocyanate composition. The other polyisocyanate may be chosen from aliphatic, cycloaliphatic, araliphatic and, preferably, aromatic polyisocyanates, such as toluene diisocyanate in the form of its 2,4 and 2,6-isomers and mixtures thereof and a prepolymer of toluene diisocyanate and a polyol derived from a natural fat/oil, a polyoxyalkylene polyol having an alkylene oxide subjected to ring-opening addition polymerization to the polyol derived from a natural fat/oil, or a polyoxyalkylene polyol derived from petroleum.

According to another embodiment, there is provided a process for producing a flexible foam by reacting and expansion-molding the polyisocyanate composition and the isocyanate-reactive hydrogen composition of the reaction system. The reaction may be conducted at an NCO index of 40-120 and preferably of 70-110. The flexible foam may have an apparent overall density varying from about 15 kg/m3 to about 150 kg/m3 and preferably from about 15 kg/m3 to about 54 kg/m3 and most preferably from about 25 kg/m3 to about 50 kg/m3 (ASTM D 3574, Test A). In another embodiment, there is provided a flexible foam produced according to the process of the present disclosure.

The moulding process may be conducted with unrestricted or restricted foam rise. Unrestricted foam rise includes feeding the polyisocyanate composition and the isocyanate-reactive hydrogen composition into an open container and allowing the foam to form and rise without a closed upper lid. The rising foam will expand vertically against the weight of the atmosphere and/or the weight of a thin film and one such example where a free-rise process may be performed is by dispensing the reaction system into a trough where it rises and cures. Restricted foam rise includes allowing the foam to rise in a container having a weight on the rising foam or allowing the foam to rise in a closed mould in which expansion is constrained by the internal dimensions of the cavity to produce a foam having a size and shape corresponding to that of the mold cavity.

Preferably the reaction is conducted with restricted foam rise and more preferably in a closed mould. The process may be conducted in any type of mould known in the art. Examples of such moulds include, but are not limited to, the moulds commercially used for making polyurethane furniture parts, automotive seating and other automotive parts, like arm rests and head-rests, bedding, mattresses etc. The material of the mould may be formed of, for example, a metal, for e.g., steel, aluminum, and an epoxy resin.

The moulding process may be a so-called cold-cure moulding process where the polyisocyanate composition and isocyanate-reactive hydrogen composition used for making the foam are fed into the mould at a temperature of from ambient temperature up to about 80° C. and preferably up to about 70° C., the mould being kept at a temperature of from ambient temperature up to 80° C. and preferably up to 70° C. during the process. After demoulding the foams are optionally cured for a period of 1 hour to 2 days at a temperature of ambient to about 100° C. and preferably of ambient temperature to about 70° C.

The various components of the reaction system can be combined in any order, although it is preferred to add the components of the polyisocyanate composition last or simultaneously with the other components of the isocyanate-reactive hydrogen composition to avoid premature reaction before the rest of the components can be added. The various components which make up the isocyanate-reactive hydrogen composition all can be combined before forming the reaction system. Alternatively, the various components of the isocyanate-reactive hydrogen composition can be combined at the same time they are combined with the components which make up the polyisocyanate composition. It is also possible to form the components of the isocyanate-reactive hydrogen composition into various sub combinations that are brought together at the same time as the polyisocyanate composition is added.

Flexible foam of the present disclosure may be useful in a variety applications, such as automotive seating, carpet, dashboard, steering wheel or instrument panels, bedding, carpet underlays, flexible packaging foam, acoustic foam, furniture seating and other “comfort” applications. Comfort applications include those in which during use the foam becomes exposed to the body heat of or water vapor evaporating from the body of a human user. The foam or an article containing the foam in such applications often supports at least a portion of the weight of a human user and the foam becomes compressed during use. Examples of such comfort applications include pillows, mattress toppers, mattresses, comforters, quilting, insulated clothing and the like. Thus, according to another embodiment, there may be provided an article comprising the flexible foam of the present disclosure. The article may be, but is not limited to, a seat cushion or a seat back for use in motor vehicles or in furniture.

The following examples are provided to illustrate the present disclosure, but are not intended to limit the scope thereof.

### EXAMPLES

### Example 1

### Synthesis of Sustainable Polyester Polyol According to the Present Disclosure

Polyethylene terephthalate (PET) pellets, diethylene glycol (DEG), triethylene glycol (TEG), polyethylene glycol 400 (PEG 400), and Tyzor® TE catalyst were added into a round bottom reactor equipped with a distillation column, a condenser and a vacuum pump. The reaction mixture was heated to 230° C. to digest the solid PET pellets. After the solid PET pellets were all digested, the temperature was increased to 240° C. and a vacuum was applied starting at 200 torr. The by-product ethylene glycol (EG) was collected, and the vacuum was gradually strengthened to 10 torr near the end of the reaction. The vacuum was then discontinued when the overhead temperature dropped below 70° C. Soybean oil (SBO) and epoxidized soybean oil (ESBO) were then added into the reactor, and the reaction was maintained at 240° C. for at least 2 hours until the material became a clear liquid without any haze. A sample was taken to confirm that the acid number was lower than 1.5 mg KOH/g and the initial OH number was also measured. Optionally, a glycol can be added to the reactor to adjust the OH number of the final product to the desired specification. The final sustainable polyester polyol was then cooled to room temperature and transferred to a container.

Various reaction systems were then prepared that included an isocyanate-reactive hydrogen composition and a polyisocyanate composition and allowed to react to produce a flexible foam. The reaction systems and foam produced from the reaction systems in this Table

TABLE 1

| | Formulation | Formulation | Formulation | Formulation | Formulation |
|---|---|---|---|---|---|
| | 1 | 2 | 3 | 4 | 5 |
| Components | PBW | PBW | PBW | PBW | PBW |
| Polyol¹ | 29.65 | 29.65 | 29.65 | 29.65 | 29.65 |
| Polyol² | 29.65 | 29.65 | 29.65 | 29.65 | 29.65 |
| Inventive Sustainable | 36.3 | 27.2 | 18.15 | 9.1 | |
| Polyester Polyol³ | | | | | |
| Veg. oil-based polyol⁴ | | 9.1 | 18.15 | 27.2 | 36.3 |
| Low emissive gel | 0.5 | 0.5 | 0.5 | 0.5 | 0.5 |
| catalyst | | | | | |
| Catalyst⁵ | 0.35 | 0.35 | 0.35 | 0.35 | 0.35 |
| Catalyst⁶ | 0.35 | 0.35 | 0.35 | 0.35 | 0.35 |
| Non emissive amine | 0.1 | 0.1 | 0.1 | 0.1 | 0.1 |
| catalyst | | | | | |
| Silicone Surfactant | 0.5 | 0.5 | 0.5 | 0.5 | 0.5 |
| Water | 3.05 | 3.05 | 3.05 | 3.05 | 3.05 |
| Total: | 100.45 | 100.45 | 100.45 | 100.45 | 100.45 |
| | PBW | PBW | PBW | PBW | PBW |
| Suprasec ® 1119 | 80.9 | 79.9 | 78.8 | 77.7 | 76.7 |
| isocyanate | | | | | |
| Primary OH Content | 60% | 45% | 30% | 15% | 0% |
| 10 min. Recession | 0.7 | 2.0 | 3.0 | 4.3 | 9.8 |

¹6000 MW EO triol (75% EO), OHv = 36
²6000 MW EO triol (28% EO), OHv = 28
* 2000 MW having a calculated primary OH content of 60%
⁴Approx. 930 MW having an OH content of 100% secondary
⁵1,3-propanediamine, N′-(3-(dimethylamino)propyl)-N, N-dimethyl
⁶N(3-dimethylaminopropyl)-N, N-diisopropanolamine
10 min. Recession = (foam height at the end of the initial rise − foam height after 10 min from the end of the initial rise)/(foam height at the end of the initial rise)
Typical 10 minute recession values for molded seating foam are usually in the range of 1-3%. As shown above in Table 1, the foam quality and stability degrade as the primary OH content of the biobased polyester polyol is reduced in the formulations. Commercial biobased polyols having no primary OH content show a significant degradation in terms of recession and foam quality.

While the foregoing is directed to embodiments of the present disclosure, other and further embodiments of the disclosure may be devised without departing from the basic scope thereof, and the scope thereof is determined by the claims that follow.

1. An isocyanate-reactive hydrogen composition comprising at least 15% by weight of a sustainable polyester polyol derived from (i) a thermoplastic polyester, (ii) a hydroxylated material, and (iii) a hydrophobic material wherein the sustainable polyester polyol has a primary hydroxyl content of at least about 30%, calculated on the number of primary and secondary hydroxyl groups in the polyester polyol and wherein the % by weight is based on the total weight of components containing an isocyanate reactive-hydrogen present in the composition.

2. The isocyanate-reactive hydrogen composition of claim 1, further comprising a first polyether polyol comprising polyether chains containing at least about 50% by weight ethylene oxide (EO), based on the total weight of the first polyether polyol.

3. The isocyanate-reactive hydrogen composition of claim 2, wherein the polyether polyol comprises polyether chains containing at least about 70% by weight EO, based on the total weight of the first polyether polyol.

4. The isocyanate-reactive hydrogen composition of claim 1, wherein the thermoplastic polyester is a recycled polyester.

5. The isocyanate-reactive hydrogen composition of claim 1, wherein the hydroxylated material is selected from (1) an aliphatic diol having a formula:
HO—R¹—OH
wherein R¹ is a divalent radical selected from the group consisting of: (a) an alkylene radical containing from 2 to 12 carbon atoms, (b) a radical of the formula:
—(R²O)ₙ−R²—
where R² is an alkylene radical containing from 2 through 4 carbon atoms, and n is an integer from 1 to 20 and (c) a mixture thereof.

6. The isocyanate-reactive composition of claim 1, wherein the hydrophobic material is a natural oil, a functionalized natural oil or a combination thereof.

7. The isocyanate-reactive composition of claim 2, wherein the first polyether polyol is present in the isocyanate-reactive hydrogen composition in an amount of from about 35%-70% by weight, based on the total weight of the components containing an isocyanate-reactive hydrogen.

8. The isocyanate-reactive composition of claim 1, further comprising water and optionally one or more of a catalyst, non-ionic surfactant, silicon-based surfactant, fire retardant, smoke suppressant, UV-stabilizer, colorant, microbial inhibitor, filler, internal mould release agent and external mould release agent.

9. The isocyanate-reactive composition of claim 1, wherein the sustainable polyester polyol has a primary hydroxyl content of at least about 45%, calculated on the number of primary and secondary hydroxyl groups in the polyester polyol.

10. A reaction system comprising (a) a polyisocyanate composition comprising an organic polyisocyanate and (b) an isocyanate-reactive composition comprising (b1) at least 15% by weight of a sustainable polyester polyol derived from (i) a thermoplastic polyester, (ii) a hydroxylated material, and (iii) a hydrophobic material wherein the sustainable polyester polyol has a primary hydroxyl content of at least about 30%, calculated on the number of primary and secondary hydroxyl groups in the polyester polyol and wherein the % by weight is based on the total weight of components containing an isocyanate reactive-hydrogen present in the composition, (b2) a first polyether polyol comprising polyether chains containing at least about 50% by weight ethylene oxide (EO), based on the total weight of the first polyether polyol and (b3) water.

11. The reaction system of claim 10, wherein the organic polyisocyanate is selected from (1) a diphenylmethane diisocyanate comprising at least 40% by weight, based on the total weight of the diphenylmethane diisocyanate of 4,4′-diphenylmethane diisocyanate (4,4′-MDI); (2) a carbodiimide and/or uretonimine modified variant of diphenylmethane diisocyanate (1) having an NCO value of 20% by weight or more; and
(3) a mixture thereof.

12. The reaction system of claim 11, wherein the organic polyisocyanate is a diphenylmethane diisocyanate comprising at least 50% by weight of 4,4′-MDI.

13. The reaction system of claim 10, wherein the isocyanate-reactive hydrogen composition further comprises a catalyst.

14. The reaction system of claim 10, wherein the sustainable polyester polyol has a primary hydroxyl content of at least about 45%, calculated on the number of primary and secondary hydroxyl groups in the polyester polyol.

15. A process for producing a flexible foam comprising reacting and expansion moulding the polyisocyanate composition and the isocyanate-reactive hydrogen composition of the reaction system of claim 10.

16. The process of claim 15, wherein the reaction may be conducted at an NCO index of 40-120.

17. A flexible foam produced according to the process of claim 15.

18. An article comprising the flexible foam of claim 17.

19. The article of claim 18, wherein the article is a seat cushion or a seat back for use in a motor vehicle or in furniture.

20. The article of claim 19 wherein the article is for use in automotive carpet, dash insulation, steering wheel or instrument panel.
